(19) United States
(12) Patent Application Publication
(10) Pub. No.: US 2026/0312381 A1
(43) Pub. Date: Oct. 8, 2026

(54) CABLE TRAY FIRE PROTECTION

(71) Applicant: Øglænd System AS, Klepp Stasjon (NO)

(72) Inventor: Arne Gya, BRYNE (NO)

(73) Assignee: Øglænd System AS, Klepp Stasjon (NO)

(21) Appl. No.: 19/485,127

(22) PCT Filed: Jun. 26, 2024
(86) PCT No.: PCT/NO2024/050148

§ 371 Date: Nov. 17, 2025

(30) Foreign Application Priority Data
Jul. 3, 2023 (NO) 20230750

(51) Int. Cl. H02G 3/04; H02G 3/00

(52) U.S. Cl. CPC H02G 3/0412; H02G 3/0418; H02G 3/0437; H02G 3/263

(57) ABSTRACT

A modular cable tray system including: a carrying element for a cable, the carrying element having a base and an upper side opposite the base, and at least two opposing side walls, each side wall having an outer side; a first and a second fire protection layer, each having a surface corresponding to the base of the carrying element, and at least two opposing side edges, wherein the first fire protection layer is configured for enveloping, in a snug fit, at least the base of the carrying element and a portion of the side walls, and the second fire protection layer is configured for covering at least the upper side of the carrying element and a portion of the side walls; and a fastening mechanism for fastening the first and the second fire protection layer to the carrying element.

### CROSS-REFERENCE TO RELATED APPLICATIONS

This application is the U.S. national stage application of International Application No. PCT/NO 2024/050148, filed Jun. 26, 2024, which international application was published on Jan. 9, 2025, as WO 2025/009977 in the English language. The International Application claims priority to Norwegian Patent Application No. 20230750, filed on Jul. 3, 2023. The international application and Norwegian application are both incorporated herein by reference, in their entirety.

### FIELD OF THE INVENTION

The invention relates to a fire protection system for carrying elements for cables, wires, tubings, pipes or the like. More specifically it relates to a modular fire protection system for carrying elements for cables, wires, tubings, pipes or the like. Furthermore, the invention relates to a fire protection layer for a carrying element for cables, wires, tubings, pipes or the like.

### BACKGROUND OF THE INVENTION

Cable tray systems are commonly used for organising tubing, electrical cables and wires and instrumentation in industrial buildings and constructions, where there might be a higher risk of fires. To ensure integrity of the cables and wires, it is therefore advantageous to protect the cable trays against overheating or fires, or at least reduce the risk of the cable trays overheating or catching fire, or at least increase the time before the cables and wires are overheated or a fire spreads to the cable trays.

Depending on the environment, the fires to protect cable trays from may be cellulosic or standard fire, hydrocarbon or pool fire, jet fire, or high-heat-flux jet fire.

Conventional methods for protecting cable trays against fire include wrapping the cable trays with fire retardant material or a fire resistant material, painting the cable trays with a fire retardant paint or a fire resistant material, or enclosing the cable trays with a ceramic or an epoxy box.

KR 101 801 110 B1 relates to a device for preventing fire in a cable tray and a method of its production. The fire prevention device includes a flame retardant member which fills and seals a space around the supported cables, and which is fixed to the surface of the cables and an inner surface of the cable tray.

KR 100 913 973 relates to a cable tray fastened to a lower cover member wherein a non-combustible material is filled within the space between the cover member and the cable tray.

KR 102 427 959 B1 relates to a cable tray comprising a combustion diffusing prevention cover equipped with an automatic grounding function.

CN 218 275 910 U relates to a cable tray comprising an inner layer and an outer layer with a fireproof filling arranged between the two layers.

U.S. Pat. No. 4,493,345 A relates to a thermal protective system comprising a mesh support structure and an active thermal protective composition applied to the support structure.

### SUMMARY OF THE INVENTION

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claim. The dependent claims define advantageous embodiments of the invention.

In a first aspect the invention relates to a modular cable tray system comprising
a carrying element for a cable, the carrying element comprising a base and an upper side opposite the base, and at least two opposing side walls, each side wall having an outer side;
a first and a second fire protection layer, each comprising a surface corresponding to the base of the carrying element, and at least two opposing side edges, wherein the first fire protection layer is configured for enveloping, when in use, in a snug fit, at least the base of the carrying element and a portion of the side walls, and the second fire protection layer is configured for, when in use, covering at least the upper side of the carrying element and a portion of the side walls and
a fastening mechanism for fastening the first and the second fire protection layer to the carrying element wherein the fastening mechanism comprises a pin on an inner side of the side edges of the first and the second fire protection layers and a catch on the outer side of the side walls of the carrying element, wherein the pin and the catch are arranged in a snap fit configuration.

The first fire protection layer may be a bottom fire protection layer. The second fire protection layer may be an upper fire protection layer.

The upper side of the carrying element may be open, or it may be covered by a lid.

The first and the second fire protection layers envelop the carrying element to protect the carrying element, and any elements it may carry, from a fire. The first and the second fire protection layers fit snugly onto the carrying element and are held in place by the fastening mechanism.

The first and the second fire protection layers are easy to install onto the carrying element. The modular cable tray system may be assembled at the site, or pre-assembled before installation at the site. Because the assembly of the modular cable tray system is easy to per-form, the quality of the fire protection of the modular cable tray system is ensured.

The cable tray system may also be realistically tested in different fire scenarios, as the components and the assembly of the modular cable tray system in the test scenarios may be the same as the components and the assembly installed on site.

The advantage of the first and the second fire protection layer having a surface that corresponds to the base of the carrying element, is that the resulting cable tray system is modular. That is, a fire protection layer can be customised to different carrying elements for cables, regardless of the shape and size of the carrying element.

In some examples, the first and second fire protection layers may not be identical. In other examples the first and second fire protection layers may be substantially identical, i.e. they may have substantially the same size and form but may still comprise minor differences, so that each of the fire protection layers covers half the height of each side wall of the carrying element. This may simplify the manufacturing as the first and the second fire protection layers may be made identical or substantially identical. Furthermore, the first and the second fire protection layers may in this case be easier to install onto the carrying element. In other examples the first and the second fire protection layers may be identical.

In order to facilitate understanding of the invention, expressions are further defined herein-after.

Throughout the description and claims the wording “carrying element” must be interpreted as a carrying element for a cable, a wire, a tubing, a pipe or the like. The carrying element may be a cable tray, a cable channel, a cable trough, a trough cable tray, a ventilated cable tray, a cable ladder, a ladder tray, etc. The carrying element may have any shape or size, such as a straight carrying element, an inside riser carrying element, an outside riser carrying element, an elbow carrying element, a tee-piece carrying element, a reducer carrying element, a bender carrying element or a cross-piece carrying element. The carrying element may be made of a metal such as stainless steel, or a fibre plastic material, or other suitable materials.

Throughout the description and claims the wording “fire protection layer” must be interpreted as a layer comprising a passive fire protection material that slows or impedes the spread of a fire from one side of the layer to the other side or retards the increase of the temperature on one side of the layer if the temperature increases on the other side of the layer.

By “protection from fire” by the fire protection layer, it is meant that the fire protection layer reduces the risk of a fire spreading from one side of the layer to the other side, or increases the time it takes before the fire passes from one side of the layer to the other side, or at least increases the time it takes before the temperature on one side of the fire protection layer increases if the temperature increases on the other side of the layer The modular cable tray system may further comprise a lid for the carrying element, the lid covering the upper side of the carrying element such that when in use, a space is formed between the base and the lid for placing of cables, and wherein the second fire protection layer is configured for enveloping, in use, in a snug fit, at least the lid of the carrying element and a portion of the side walls.

The lid may increase the stability of the modular cable tray system as the second fire protection layer is resting on top of the lid.

In an embodiment of the modular cable tray system according to the invention, the fastening mechanism may comprise a plurality of strips configured for, in use, enveloping the first and the second fire protection layers. Fastening the plurality of strips may be an easy method for ensuring that the first and the second fire protection layers are fastened to the carrying element.

The snap fit configuration of the pin and the catch makes the assembly and disassembly of the modular cable tray system easy. The first fire protection layer may simply be positioned under the base of the carrying element, with the side edges covering a portion of the side walls of the carrying element, and the pin may be inserted onto the catch so that the pin may abut the catch. Similarly for the second fire protection layer which may be positioned at the upper side of the carrying element or onto the lid, with the side edges covering another portion of the side walls of the carrying element, and the pin may be inserted onto the catch so that the pin may abut the catch.

The fastening mechanism may comprise a lower cladding part and an upper cladding part, configured for enclosing, in use, the carrying element, with or without the lid, enveloped with the first and the second fire protection layers. The upper and lower cladding part may be fastened to each other by mechanical fastening means such as bolts and nuts. The upper and lower cladding part may be made out of a metal such as steel, or a ceramic material, or other suitable materials.

The upper and lower cladding part may ensure that the first and second fire protection layers are kept in place while enveloping the carrying element, with or without the lid. It may also present an additional fire protection for the modular cable tray system.

A surface of the upper and lower cladding part may correspond to the base of the carrying element, so that the resulting cable tray system is modular. That is, an upper and lower cladding part may be customised to different carrying elements, regardless of the shape and size of the carrying element.

The fastening mechanism may comprise a pin on an outer side of the side edges of the first and the second fire protection layer, and a catch on an inner side of a side wall of the lower or upper cladding part, wherein the pin and the catch are arranged in a snap fit configuration.

In an embodiment of the modular cable tray system according to the invention, the first fire protection layer may expand when exposed to heat. The first fire protection layer may be provided with first spacers that, when in use, create first expansion spaces between the first fire protection layer and the base.

The second fire protection layer may expand when exposed to heat, and the second fire protection layer may be provided with second spacers that, when in use, create second expansion spaces between the second fire protection layer and the lid.

The first and the second fire protection layers may expand when exposed to heat from a fire.

The first and the second fire protection layers, expanding when exposed to heat, may expand into the first and the second expansion spaces. The expanding first and second fire protection layers may also close any gaps that may have been introduced into the modular cable tray system during installation, for example where two carrying elements are connected. The expanding first and second fire protection layers may therefore reduce the risk of heat bridges to occur. The carrying element and any, elements it may carry, may therefore be protected from a fire.

For high-temperature fires such as hydrocarbon or pool fire, jet fire, or high-heat-flux jet fire, it may be advantageous to enclose the carrying element and the lid, enveloped with the first and the second fire protection layers, with the upper and lower cladding parts. The upper and lower cladding parts may ensure that the first and second fire protection layers expand inwardly into the first and second expansion spaces. For cellulosic fires, the upper and lower cladding parts are optional.

The modular cable tray system may further comprise a support structure, wherein the support structure comprises a third fire protection layer that, in use, envelops the support structure in a snug fit, and wherein the support structure comprises a support cladding configured for enclosing, in use, the support structure enveloped with the third fire protection layer.

The support structure may be used to secure the carrying element, enveloped with the first and the second fire protection layer, with or without the upper and lower cladding parts, to a part of a construction, such as a roof or a wall.

By enveloping the support structure with a third fire protection layer, heat transfer from the support structure to the carrying element may be prevented, or at least reduced, in case of a fire.

The third fire protection layer may be tailor-made for components of the support structure. A fire protection layer can be made to fit snugly onto a component of the support structure, regardless of the shape or size of the component.

The third fire protection layer may expand when exposed to heat, and the third fire protection layer may be provided with third spacers that, when in use, create third expansion spaces between the third fire protection layer and the support structure.

The third fire protection layer may expand when exposed to heat from a fire.

The third fire protection layer, expanding when exposed to heat, may expand into the third expansion spaces. The expanding third fire protection layer may also close any gaps that may have been introduced into the modular cable tray system during installation, so the expanding third fire protection layer may reduce the risk of heat bridges to occur. The support structure and the carrying element supported by the support structure, and any elements it may carry, may therefore be protected from a fire.

In another example, the third fire protection layer may not be provided with third spacers. The support structure may comprise a bracket for fastening the carrying element to the support structure, and a fourth fire protection layer comprising a surface corresponding to a part of the base of the carrying element, and at least two opposing side edges. The fourth fire protection layer is positioned, when in use, between the bracket and the part of the base of the carrying element, and the fourth fire protection layer may be configured for enveloping, in a snug fit, at least the part of the base of the carrying element and a portion of the side walls of the carrying element.

By positioning the fourth fire protection layer between the bracket and the carrying element, the risk of heat transfer from the support structure to the carrying element, in case of a fire, may be reduced.

An inner side of each side edge of the fourth fire protection layer may be provided with a pin, and the outer side of each side wall of the carrying element may be provided with a respective catch, such that each pin and each catch may be arranged in a snap fit configuration.

In another example, the fastening mechanism may comprise another type of releasably locking mechanisms.

The fourth fire protection layer may expand when exposed to heat, and the fourth fire protection layer may be provided with fourth spacers that, when in use, create fourth expansion spaces between the fourth fire protection layer and the carrying element.

The fourth fire protection layer may expand when exposed to heat from a fire.

The fourth fire protection layer, expanding when exposed to heat, may expand into the fourth expansion spaces. The expanding fourth fire protection layer may also close any gaps that may have been introduced into the modular cable tray system during installation, so the expanding fourth fire protection layer may reduce the risk of heat bridges to occur. The support structure and the carrying element fastened to the support structure by the bracket, and any elements the carrying element may carry, may therefore be protected from a fire.

The first, second, third and fourth fire protection layers may be adjusted depending on the environment where the modular cable tray system is installed. Different environment present different risk of fire and different fires to protect from. For environments with a risk of high-temperature fires such as hydrocarbon or pool fire, jet fire, or high-heat-flux jet fire, the fire protection layer may comprise another material than for environments with a risk of cellulosic fire. The thickness of the fire protection layers may also be increased or decreased depending on the risk environment.

The first, second, third and fourth fire protection layers may comprise a polymer-based fire protection material. The first, second, third and fourth fire protection layers may comprise mineral wool.

In a second aspect the invention relates to a fire protection layer for a carrying element for a cable, the carrying element comprising a base and at least two opposing side walls. The fire protection layer comprises:
a surface corresponding to the base of the carrying element;
at least two opposing side edges;
a pin on an inner side of each of the side edges arranged to be, when in use, in a snap fit configuration with a corresponding catch on an outer side of each of the side walls of the carrying element; and
spacers on the surface;
wherein the fire protection layer is configured for enveloping, in use, in a snug fit, at least the base of the carrying element and a portion of the side walls, and wherein the fire protection layer expands when exposed to heat.

In a third aspect the invention relates to a fire protection layer for a carrying element for a cable, the carrying element comprising a base and at least two opposing side walls, and wherein the fire protection layer comprises:
a surface corresponding to the base of the carrying element;
at least two opposing side edges;
a pin on an outer side of each of the side edges arranged to be, when in use, in a snap fit configuration with a corresponding catch on an inner side of a side wall of a cladding for the carrying element; and
spacers on the surface;
wherein the fire protection layer is configured for enveloping, in use, in a snug fit, at least the base of the carrying element and a portion of the side walls, and the fire protection layer expands when exposed to heat.

The fire protection layer of the second and third aspect of the invention may be tailor-made for different components of a modular cable tray system. A fire protection layer can be made to fit snugly onto a carrying element of a modular cable tray system, regardless of the shape or size of the carrying element.

The snap fit configuration of the pin on the fire protection layer and the catch of either the carrying element or the cladding of the carrying element, makes the fire protection layer easy to assemble with the carrying element. The fire protection layer may easily be positioned onto the carrying element, and the pin may be “snapped” onto the catch, so that the fire protection layer is fastened onto the carrying element. The fire protection layer may easily me positioned inside the cladding, and the cladding may be assembled with the carrying element. Either installation may ensure that the fire protection layer is enclosing the carrying element.

The fire protection layers according to the second or third aspect of the invention may expand when exposed to heat from a fire.

The fire protection layer, expanding when exposed to heat, may expand into the expansion spaces. The fire protection layer may close any gaps that may have been introduced when assembling the fire protection layer with the carrying element, so the expanding fire protection layer may reduce the risk of heat bridges to occur. The carrying element, and any elements it may carry, may therefore be protected from a fire.

For high-temperature fires such as hydrocarbon or pool fire, jet fire, or high-heat-flux jet fire, it may be advantageous to enclose the carrying element, enveloped with the fire protection layer, with the cladding. The cladding may ensure that the fire protection layer expands inwardly towards the expansion spaces formed between the spacers. For cellulosic fires, the cladding may be optional.

The spacers of the fire protection layer according to the second or third aspect of the invention may be provided on an inner side of the surface of the fire protection layer.

The spacers of the inner side of the surface form expansions areas between the fire protection layer and the carrying element when assembled. The expansions areas provide space for fastening devices such as screws, nuts and bolts that may be used for fastening a cable or the like to the carrying element.

### BRIEF INTRODUCTION OF THE FIGURES

In the following is described an example of a preferred embodiment illustrated in the accompanying drawings, wherein:

FIG. 1 shows a carrying element in perspective;

FIG. 2 shows a side view of the carrying element of FIG. 1;

FIG. 3 shows another side view of the carrying element of FIG. 1;

FIG. 3 shows another side view of the carrying element of FIG. 1;

FIG. 4 shows a fire protection layer in perspective;

FIG. 5 shows a cross section of the fire protection layer of FIG. 4, along the line A-A;

FIG. 6 shows an exploded view of a modular cable tray system;

FIG. 7 shows a side view of a cable tray system in an exploded view;

FIG. 8 shows a side view of an assembled cable tray system; and

FIG. 9 shows an exploded view of a support structure for a carrying element.

### DETAILED DESCRIPTION OF THE EMBODIMENTS

Any positional indications refer to the position shown in the figures. Through the description and the claims, position indications such as “upper” and “lower”, “top” and “bottom”, or “horizontal” and “vertical”, etc., denotes the position the components of the system has in the subsequent figures, which is also a natural or practical functional position of the components.

In the figures, same or corresponding elements are indicated by same reference numerals. For clarity reasons, some elements may in some of the figures be with-out reference numerals.

A person skilled in the art will understand that the figures are just principal drawings. The relative proportions of individual elements may also be distorted.

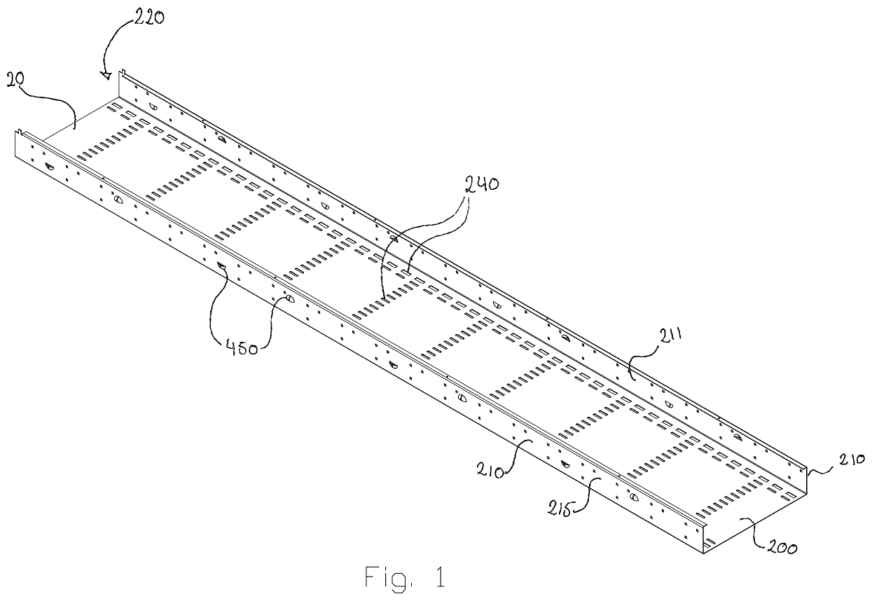

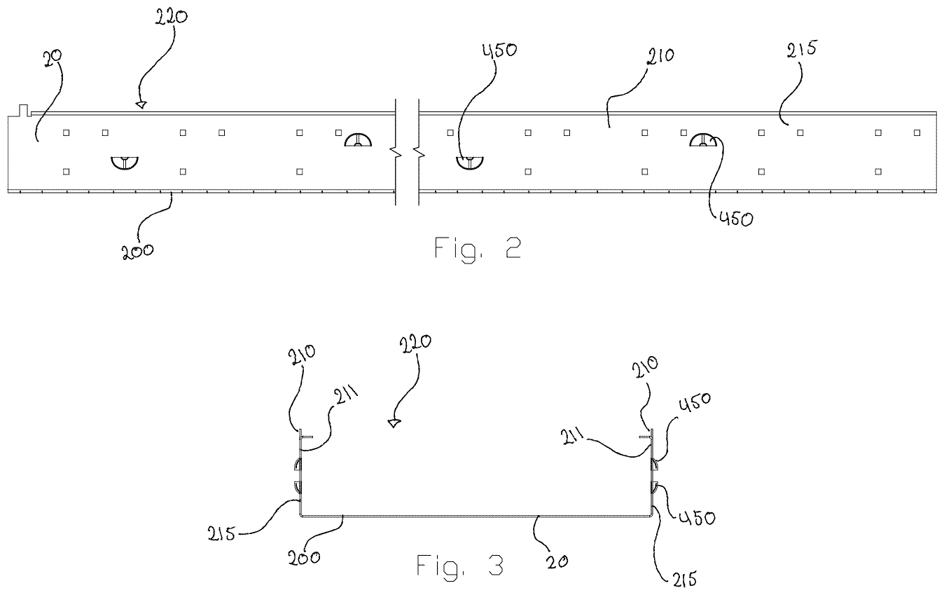

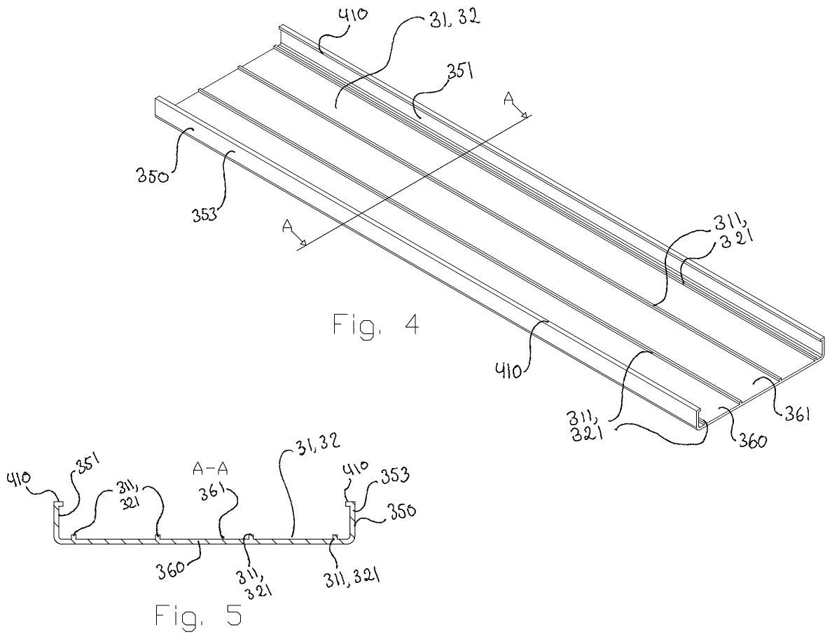

In the figures, the reference number 1 denotes a modular cable tray system 1. The modular cable tray system 1 comprises a carrying element for a cable (not shown), here shown as a cable tray 20 (see FIGS. 1 to 3). The cable tray 20 comprises a base 200 and two opposing side walls 210 extending from the base 200. The area extending between the upper edges of the sidewalls define an upper side 220 of the cable tray 20. The modular cable tray system further comprises a fire protection layer 31, 32 (see FIGS. 4 and 5) comprising a surface 360 corresponding to the base 200 of the cable tray 20, and two opposing side edges 350 extending from the surface 360.

The base 200 of the cable tray 20 shown in FIG. 1 is elongated in one direction. Each side wall 210 extends upwards from the long edges of the base 200. The cable tray 20 is open ended at the two short sides. Further carrying elements (not shown), such as cable trays may be connected at the open ends. Cables, wires, tubings, pipes or the like (not shown) may be positioned onto the base 200 of the cable tray 20 and onto the connected further carrying elements. The base 200 is provided with a plurality of apertures 240. The cables, wires, tubings, pipes or the like may be fastened to the base 200 by for example strips fastened to the apertures 240 as known per se.

FIG. 4 shows a fire protection layer 31, 32, comprising a surface 360. The surface 360 corresponds to the base 200 of the cable tray 20 and is elongated in one direction. At the two long sides of the surface 360, two opposing side edges 350 are protruding from the surface 360. The side edges 350 comprises an inner side 351 and an outer side 353. Each inner side 351 is provided with a pin 410 in the shape of a flange protruding inwardly towards the opposite side edge 350. The pins 410, together with corresponding catches 450 on the cable tray 20, provide a fastening mechanism for fastening the fire protection layer 31, 32 to the carrying element 20 as described below. The flange extends continuously along the side edges 350. The flange makes it easy to install the fire protection layer 31, 32 onto the cable tray 20 because the flange is easily aligned with one of the catches 450.

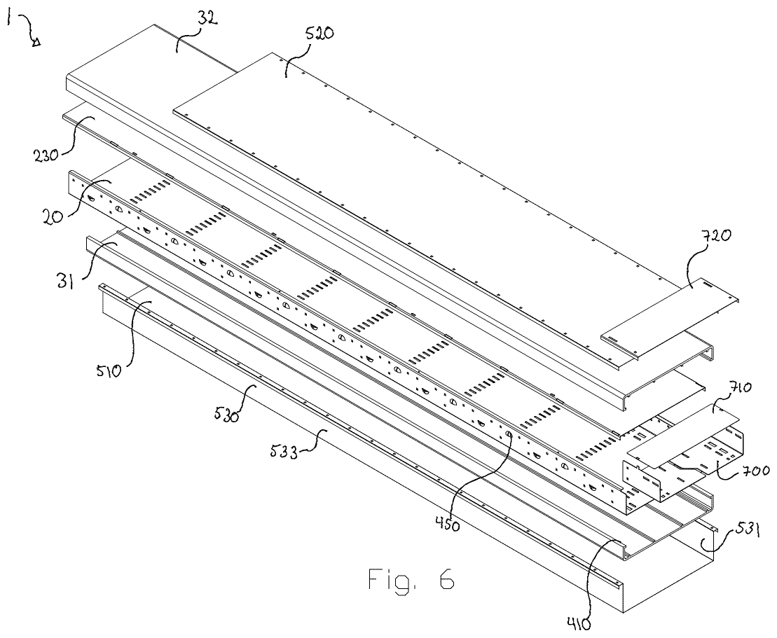

Referring to FIGS. 6 to 8 showing a cable tray system 1 according to the invention. The cable tray system 1 comprises the cable tray 20 as it's innermost part. The cable tray 20 is provided with a removable lid 230 in the FIGS. 6 to 8. A first fire protection layer 31 is positioned below the base 200 of the cable tray 20. A second fire protection layer 32 is positioned above the lid 230. In the example shown in FIGS. 6 to 8, the first and the second fire protection layers 31, 32 are identical.

When assembled, as shown in FIG. 8, the first and the second fire protection layer 31, 32 fit snugly around the cable tray 20 comprising the lid 230. Each side wall 210 of the cable tray 20 is provided with a plurality of catches 450 on an outer side 215. The catches 450 are facing upwards and downwards in an alternating manner. When assembled, the pins 410 of the first fire protection layer 31 form a snap-fit configuration with the upwards facing catches 450, as can be seen in FIG. 8. That is, a lower edge of the pin 410 of the first fire protection layer 31 is abutting against the flat, upwards-facing side of the catch 450 to hinder downwards movement of the first fire protection layer 31 in relative to the cable tray 20. Similarly, when assembled, the pins 410 of the second fire protection layer 32 form a snap-fit configuration with the downwards facing catches 450, as can be seen in FIG. 8.

That is, an upper edge of the pin 410 of the second fire protection layer 32 is abutting against the flat, downwards-facing side of the catch 450 to hinder upwards movement of the second fire protection layer 32 in relative to the cable tray 20.

The fire protection layers 31, 32 may comprise a resilient material so that the pin 410 on one of the side edges 350 is biased inwardly towards the opposite side edge 350. When assembling a fire protection layer 31, 32 comprising a resilient material, with a cable tray 20, one may easily pull the two side edges 350 outwardly, and thread the fire protection layer 31, 32 onto the base 200 or onto the lid 230 of the cable tray 20. The alternating catches 450 make it easier to assemble the cable tray system 1. In another example (not shown), the upwards-facing catches may be positioned directly below the downwards-facing catches.

The fire protection layers 31, 32 may also be slid onto the cable tray 20.

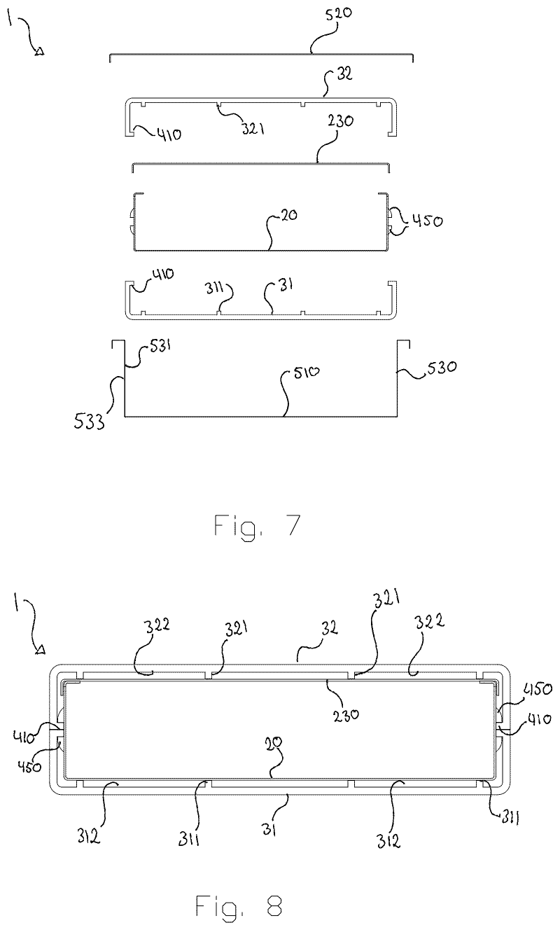

The modular cable tray system 1 shown in FIGS. 6 and 7 further comprises a lower cladding part 510 and an upper cladding part 520 enclosing the cable tray 20, the lid 230, the first and the second fire protection layers 31, 32. The upper and lower cladding parts 510, 520 have a shape corresponding to the shape of the cable tray 20. The lower cladding part 510 comprises two opposing cladding side walls 530, which each comprises an inner side 531 and an outer side 533. The upper edge of the outer side 533 is provided with an outwardly protruding flange that abuts the upper cladding part 520 when the modular cable tray system 1 is assembled. The upper and lower cladding parts 510, 520 may be fastened together by for example nuts and bolts.

The modular cable tray system 1 shown in FIG. 6 further comprises a splicer 700 and a splicer lid 710 for connecting with a further carrying element (not shown). A splicer cladding part 720 may be connected to the upper cladding part 520 and the upper cladding part (not shown) of the further carrying element.

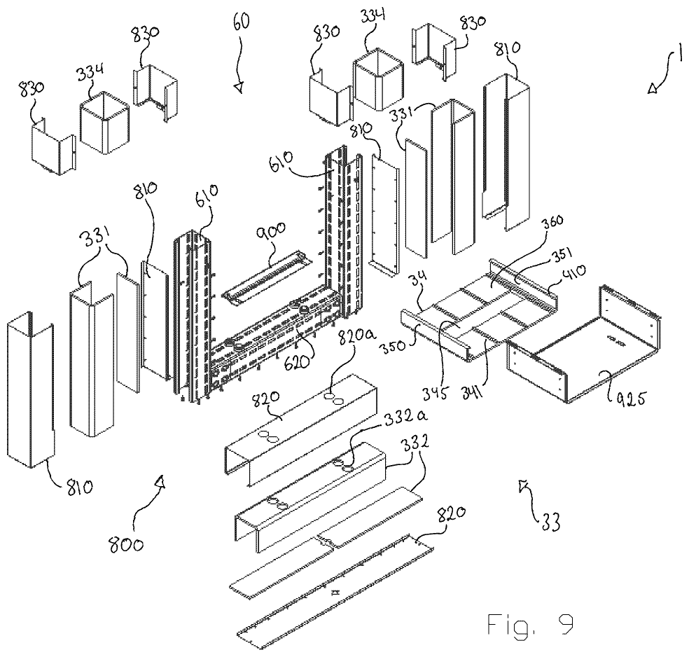

The modular cable tray system 1 comprises further a support structure 60, shown in FIG. 9. The support structure 60 fastens, when installed, a carrying element to a part of a construction (not shown) such as a wall or a ceiling. The support structure 60 shown in FIG. 9 is configured for fastening a carrying element, such as the cable tray 20 in FIGS. 1 to 3, to a ceiling. The support structure 60 comprises two beams 610 and a mid-beam 620 fastened at each end to a lower part of the two beams 610. The beams 610 and the mid-beam 620 may be hollow structures such as channels. The two beams 610 are connected to a ceiling (not shown) at an upper part of the two beams 610. A bracket 900 is connected to an upper side of the mid-beam 620. A carrying element, such as a cable tray 20, may be fastened to the bracket 900 by mechanical fastening means such as bolts and nuts, so that the carrying element is supported by the support structure 60.

Third fire protection layers 33 envelop the support structure 60 as shown in FIG. 9. The third fire protection layers 33 comprises sub-layers 331, 332, 334 corresponding to each part of the support structure 60. Each beam 610 is enveloped, in a snug fit, by a sub-layer 331, and the mid-beam 620 is enveloped, in a snug fit, by a sub-layer 332. The connection point (not shown) between the upper part of the two beams and the ceiling is enclosed by a sub-layer 334.

To fasten the third fire protection layer 33 onto the support structure 60, a support cladding 800 is provided. The support cladding comprises sub-cladding 810, 820, 830 corresponding to each part of the support structure 60. A sub-cladding 810 encloses each beam 610, enveloped by the sub-layer 331. The mid-beam 620, enveloped by the sub-layer 332, is enclosed with a sub-cladding 820. The connection point, enclosed by the sub-layer 334, is enclosed with a sub-cladding 830. The sub-claddings are fastened by mechanical fastening means.

A fourth fire protection layer 34, and a corresponding bracket cladding 925, are positioned between the bracket 900 and the mid-beam 620. The fourth fire protection layer 34 is provided with an aperture 345, the sub-layer 332 is provided with apertures 332a, and the sub-cladding 820 is provided with apertures 820a, so that bolts may pass through these different layers and secure the bracket to the support 60.

The fourth fire protection layer 34 comprises a surface 360 that corresponds to a part of the base 200 of the cable tray 20. Two opposing side edges 350 are protruding from the surface 360. The side edges 350 comprises an inner side 351 wherein each inner side 351 is provided with a pin 410 in the shape of a flange protruding inwardly towards the opposite side edge 350. The pins 410, together with corresponding catches 450 on the cable tray 20, provides a fastening mechanism for fastening the fire protection layer 34 to the carrying element 20 as described above for the first and second fire protection layers 31, 32. The flange extends continuously along the side edges 350. The flange makes it easy to install the fire protection layer 31, 32 onto the cable tray 20 because the flange is easily aligned with one of the catches 450.

The flange of the first, second and fourth fire protection layers 31, 32, 34 may in another embodiment (not shown), be extending outwards from the side edges 350, so that the flange may form a snap-fit configuration with corresponding catches (not shown) on the cladding.

In the example shown in FIG. 9, the area of the surface 360 of the fourth fire protection layer 34 is larger than the bracket 900, to reduce the risk of a heat bridge to occur between the support structure 60 and the carrying element.

The first, second and fourth fire protection layers 31, 32, 34 expand when exposed to heat, such as from a fire. The first, second and fourth fire protection layers 31, 32, 34 are provided with first, second and fourth spacers 311, 321, 341 respectively. The first, second and fourth spacers 311, 321, 341, when in use, create first, second 312, 322 and fourth (not shown) expansion spaces between the first fire protection layer 31 and the base 200 of the cable tray 20, between the second fire protection layer 32 and the lid 230, and between the fourth fire protection layer 34 and the base 200 of the cable tray 20.

The third fire protection layer 33 is not provided with spacers in the example shown in FIG. 9, however, in another example (not shown) the third fire protection layer 33 may be provided with spacers.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1.-16. (canceled)

17. A modular cable tray system comprising:
a carrying element for a cable, the carrying element comprising a base and an upper side opposite the base, and at least two opposing side walls, each side wall having an outer side; and
a first and a second fire protection layer, each comprising a surface corresponding to the base of the carrying element, and at least two opposing side edges;
wherein the first fire protection layer is configured for enveloping, when in use, in a snug fit, at least the base of the carrying element and a portion of the side walls, and the second fire protection layer is configured for, when in use, covering at least the upper side of the carrying element and a portion of the side walls; and
a fastening mechanism for fastening the first and the second fire protection layer to the carrying element,
wherein that the fastening mechanism comprises a pin on an inner side of the side edges of the first and the second fire protection layers, and a catch on the outer side of the side walls of the carrying element, wherein the pin and the catch are arranged in a snap fit configuration.

18. The modular cable tray system according to claim 17, further comprising a lid for the carrying element, the lid covering the upper side of the carrying element such that when in use, a space is formed between the base and the lid for placing of cables, and wherein the second fire protection layer is configured for enveloping, in use, in a snug fit, at least the lid of the carrying element and a portion of the side walls.

19. The modular cable tray system according to claim 18, wherein the fastening mechanism comprises a plurality of strips enveloping, when in use, the first and the second fire protection layers.

20. The modular cable tray system according to claim 17, wherein the fastening mechanism comprises a plurality of strips enveloping, when in use, the first and the second fire protection layers.

21. The modular cable tray system according to claim 17, wherein the fastening mechanism comprises a lower cladding part and an upper cladding part, configured for enclosing, in use, the carrying element enveloped with the first and the second fire protection layers.

22. The modular cable tray system according to claim 21, wherein the fastening mechanism comprises a pin on an outer side of the side edges of the first and the second fire protection layer, and a catch on an inner side of a side wall of the lower or upper cladding part, wherein the pin and the catch are arranged in a snap fit configuration.

23. The modular cable tray system according to claim 17, wherein the first fire protection layer expands when exposed to heat and wherein the first fire protection layer is provided with first spacers that, when in use, create first expansion spaces between the first fire protection layer and the base.

24. The modular cable tray system according to claim 18, wherein the second fire protection layer expands when exposed to heat, and wherein the second fire protection layer is provided with second spacers that, when in use, create second expansion spaces between the second fire protection layer and the lid.

25. The modular cable tray system according to claim 17, wherein the modular cable tray system further comprises a support structure, and a third fire protection layer that, in use, envelops the support structure in a snug fit, and wherein the support structure comprises a support cladding configured for enclosing, in use, the support structure enveloped with the third fire protection layer.

26. The modular cable tray system according to claim 25, wherein the third fire protection layer expands when exposed to heat, and wherein the third fire protection layer is provided with third spacers that, when in use, create third expansion spaces between the third fire protection layer and the support structure.

27. The modular cable tray system according to claim 26, wherein the support structure comprises:
a bracket for fastening the carrying element to the support structure; and
a fourth fire protection layer comprising a surface corresponding to a part of the base of the carrying element, and at least two opposing side edges;
wherein the fourth fire protection layer is positioned, when in use, between the bracket and the part of the base of the carrying element, and the fourth fire protection layer is configured for enveloping, in a snug fit, at least the part of the base of the carrying element and a portion of the side walls of the carrying element.

28. The modular cable tray system according to claim 25, wherein the support structure comprises:
a bracket for fastening the carrying element to the support structure; and
a fourth fire protection layer comprising a surface corresponding to a part of the base of the carrying element, and at least two opposing side edges;
wherein the fourth fire protection layer is positioned, when in use, between the bracket and the part of the base of the carrying element, and the fourth fire protection layer is configured for enveloping, in a snug fit, at least the part of the base of the carrying element and a portion of the side walls of the carrying element.

29. The modular cable tray system according to claim 27, wherein an inner side of each side edges of the fourth fire protection layer is provided with a pin, and wherein the outer side of each side wall of the carrying element is provided with a respective catch, such that each pin and each catch is arranged in a snap fit configuration.

30. The modular cable tray system according to claim 29, wherein the fourth fire protection layer expands when exposed to heat, and wherein the fourth fire protection layer is provided with fourth spacers that, when in use, create fourth expansion spaces between the fourth fire protection layer and the carrying element.

31. The modular cable tray system according to claim 28, wherein the fourth fire protection layer expands when exposed to heat, and wherein the fourth fire protection layer is provided with fourth spacers that, when in use, create fourth expansion spaces between the fourth fire protection layer and the carrying element.

32. A fire protection layer for a carrying element for a cable, the carrying element comprising a base and at least two opposing side walls, wherein the fire protection layer comprises:
a surface corresponding to the base of the carrying element;
at least two opposing side edges;
a pin on an inner side of each of the side edges arranged to be, when in use, in a snap fit configuration with a corresponding catch on an outer side of each of the side walls of the carrying element; and
spacers on the surface;
wherein the fire protection layer is configured for enveloping, in use, in a snug fit, at least the base of the carrying element and a portion of the side walls, and wherein the fire protection layer expands when exposed to heat.

33. The fire protection layer according to claim 32, wherein the spacers are provided on an inner side of the surface.

34. A fire protection layer for a carrying element for a cable, the carrying element comprising a base and at least two opposing side walls, and wherein the fire protection layer comprises:
a surface corresponding to the base of the carrying element;
at least two opposing side edges;
a pin on an outer side of each of the side edges arranged to be, when in use, in a snap fit configuration with a corresponding catch on an inner side of a side wall of a cladding for the carrying element; and
spacers on the surface;
wherein the fire protection layer is configured for enveloping, in use, in a snug fit, at least the base of the carrying element and a portion of the side walls, and the fire protection layer expands when exposed to heat.

35. The fire protection layer according to claim 34, wherein the spacers are provided on an inner side of the surface.
